(19) United States
(12) Patent Application Publication
(10) Pub. No.: US 2021/0279207 A1
(43) Pub. Date: Sep. 9, 2021

(54) DATA ANALYSIS AND MACHINE LEARNING FOR ENHANCING EYE CONTACT FILE TRANSFERS IN COMBINATION WITH BODY MOVEMENT

(71) Applicant: International Business Machines Corporation, Armonk, NY (US)

(72) Inventors: Stan Kevin Daley, Atlanta, GA (US); Gordan G. Greenlee, Endicott, NY (US); Michael Bender, Rye Brook, NY (US); Sarbajit K. Rakshit, Kolkata (IN)

(21) Appl. No.: 16/808,909

(22) Filed: Mar. 4, 2020

(51) Int. Cl. G06F 16/16; G06F 3/01

(52) U.S. Cl. CPC G06F 16/168; G06N 20/00; G06F 3/017; G06F 3/013

(57) ABSTRACT

The present disclosure includes initiating file transfers between devices based on a combination of a gaze of a user and a physical gesture of one or more users. Using an eye tracking device, it is detected when a user is gazing in a specified direction. Using a movement detection device, it is detected when the user makes a specified physical gesture. A threshold combination of the gazing in the specified direction and the specified physical gesture is met is determined. A specified file is transferred to a specified location, in response to the threshold combination being met.

### BACKGROUND

The present disclosure relates to detecting and analyzing visual tracking data or eye movement information, in combination with a physical motion or physical queues from a person, for initiating a file transfer between devices.

Different techniques are known for initiating file transfers between devices. In one example file transfers can be initiated between smart devices or mobile devices. Some of these techniques do not require working through a user interface of a smart device. In one example, a file transfer between devices can be initiated by determining that two parties are looking at each other, for example, using an eye gaze tracker. In another example, a physical movement can initiate a file transfer, such as physical touching two devices to each other initiating a file transfer.

### SUMMARY

The present disclosure recognizes the shortcomings and problems associated with current systems for initiating file transfers using visual tracking such as determining eye movement or direction of eye gazing.

In one embodiment according to the present invention, visual tracking data may be generated from an eye gaze tracking device, in combination with a physical motion, for initiating a file transfer between smart devices of two or more users.

In embodiments of the present invention a person's body gestures, movements, or signals, supplement or act in concert with, eye gazing or eye movements as a trigger or to initiate a file transfer. File transfers are validated using the above two-step process so that an accidental initiation of a file transfer does not transpire. In addition, body motions, gestures, or movements by multiple people can allow for initiating a file transfer to multiple parties.

In one aspect according to the present invention a method includes initiating file transfers between devices based on a combination of a gaze of a user and a physical gesture of one or more users. The method includes detecting, using an eye tracking device, when a user is gazing in a specified direction, and detecting, using a movement detection device, when the user makes a specified physical gesture. The method incudes determining when a threshold combination of the gazing in the specified direction and the specified physical gesture is met; and transferring a specified file to a specified location, in response to the threshold combination being met.

In a related aspect, the method includes registering the user's device for a file transfer, and authorizing tracking of the user's gaze using the visual detection device.

In a related aspect, wherein the detecting of gazing includes determining when the user is gazing at in the specified direction using evaluation of eye movements and projected line of sight.

In a related aspect, the method includes detecting gazing, using one or more eye tracking devices, between two or more users; detecting, using a movement detection device, when at least one of the users makes a specified physical gesture; determining when a threshold combination of the gazing is occurring in a specified direction and the specified physical gesture is met; and transferring a specified file to a specified location, in response to the determination that the combination of the gazing in the specified direction is occurring contemporaneously as the specified physical gesture.

In a related aspect, the method includes registering a plurality of devices for respective users for a file transfer, and authorizing gaze tracking for a plurality of users.

In a related aspect, wherein the detecting of gazing includes determining when at least one of the two or more users are gazing at another one of the two or more users using evaluation of eye movements and projected line of sight.

In a related aspect, the method includes detecting gazing, using one or more eye tracking devices, between two or more users; detecting, using a movement detection device, when at least one of the users makes a specified physical gesture; determining when a combination of the gazing is occurring in a specified direction is occurring contemporaneously as the specified physical gesture; and transferring a specified file to a specified location, in response to the determination that the combination of the gazing in the specified direction is occurring contemporaneously as the specified physical gesture.

In a related aspect, wherein the eye tracking device is selected from a group consisting of: a camera; a mobile device camera; a video camera, and a computer camera.

In a related aspect, the method includes defining a threshold time for the combination of the gazing occurring in the specified direction occurring contemporaneously with the specified physical gesture.

In a related aspect, wherein the threshold combination defines the combination of the gazing in the specified direction occurring contemporaneously with the specified physical gesture.

In a related aspect, wherein the combination of the gazing in the specified direction occurs near simultaneously with the specified physical gesture.

In a related aspect, wherein the combination of the gazing in the specified direction occurs in an overlapping time period.

In a related aspect, wherein the combination of the gazing in the specified direction occurs in within a defined time period.

In another aspect according to the present invention, a system includes initiating file transfers between devices based on a combination of a gaze of a user and a physical gesture of one or more users. A computer system comprising, a computer processor, a computer-readable storage medium, and program instructions stored on the computer-readable storage medium being executable by the processor, to cause the computer system to perform functions, by the computer, comprising, the following functions to: detect, using an eye tracking device, when a user is gazing in a specified direction; detect, using a movement detection device, when the user makes a specified physical gesture; determine when a threshold combination of the gazing in the specified direction and the specified physical gesture is met; and transfer a specified file to a specified location, in response to the threshold combination being met.

In a related aspect, the system includes further comprising the following function to: register the user's device for a file transfer, and authorizing tracking of the user's gaze using the visual detection device.

In a related aspect, wherein the detecting of gazing includes determining when the user is gazing at in the specified direction using evaluation of eye movements and projected line of sight.

In a related aspect, the system includes the following function to: detect gazing, using one or more eye tracking devices, between two or more users; detect, using a movement detection device, when at least one of the users makes a specified physical gesture; determine when a threshold combination of the gazing is occurring in a specified direction and the specified physical gesture is met; and transfer a specified file to a specified location, in response to the determination that the combination of the gazing in the specified direction is occurring contemporaneously as the specified physical gesture.

In a related aspect, the system includes the following function to: register a plurality of devices for respective users for a file transfer, and authorizing gaze tracking for a plurality of users.

In a related aspect, wherein the detecting of gazing includes determining when at least one of the two or more users are gazing at another one of the two or more users using evaluation of eye movements and projected line of sight.

In another aspect according to the present invention, a computer program product includes cognitive data analytics for initiating file transfers between devices based on a combination of a gaze of a user and a physical gesture of one or more users. The computer program product comprises a computer readable storage medium having program instructions embodied therewith, the program instructions executable by a computer to cause the computer to perform functions, by the computer, comprising the functions to: detect, using an eye tracking device, when a user is gazing in a specified direction; detect, using a movement detection device, when the user makes a specified physical gesture; determine when a threshold combination of the gazing in the specified direction and the specified physical gesture is met; and transfer a specified file to a specified location, in response to the threshold combination being met.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram illustrating an overview of a system and methodology for initiating file transfers between devices based on a combination of a gaze of a user and a physical gesture of one or more users, according to an embodiment of the invention.

FIG. 2 is a flow chart illustrating a method, implemented using the system shown in FIG. 1, for initiating file transfers between devices based on a combination of a gaze of a user and a physical gesture of one or more users, according to an embodiment of the present invention.

FIG. 3 is a flow chart continuing from the flow chart shown in FIG. 2 depicting a continuation of the method shown in FIG. 2, according to an embodiment of the invention.

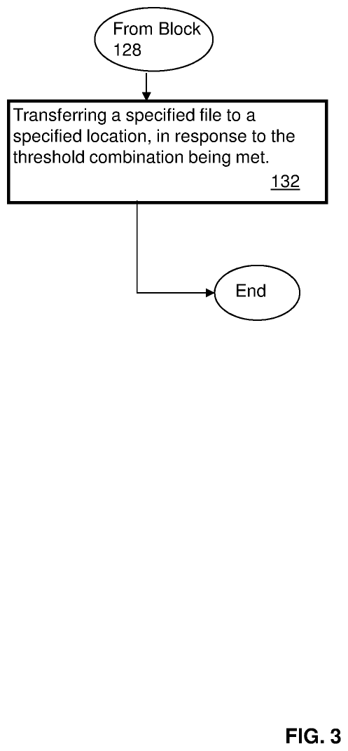

FIG. 4 is a flow chart illustrating another embodiment of a method according to the present disclosure, implemented using the system shown in FIG. 1, for initiating file transfers between devices based on a combination of a gaze of a user and a physical gesture of one or more users, according to an embodiment of the present invention.

FIG. 5 is a flow chart continuing from the flow chart shown in FIG. 4 depicting a continuation of the method shown in FIG. 4, according to an embodiment of the invention.

FIG. 6 is a functional schematic block diagram for instructional purposes illustrating features of the present disclosure associated with the embodiments shown in FIGS. 1, 2, 3, 4 and 5, for initiating file transfers between devices based on a combination of a gaze of a user and a physical gesture of one or more users, according to embodiments of the invention.

FIG. 7 is a schematic block diagram depicting a computer system according to an embodiment of the disclosure which may be incorporated, all or in part, in one or more computers or devices shown in FIG. 1, and cooperates with the systems and methods shown in FIGS. 1, 2, 3, 4, 5 and 6.

FIG. 8 is a schematic block diagram of a system depicting system components interconnected using a bus. The components for use, in all or in part, with the embodiments of the present disclosure, in accordance with one or more embodiments of the present disclosure.

FIG. 9 is a block diagram depicting a cloud computing environment according to an embodiment of the present invention.

FIG. 10 is a block diagram depicting abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

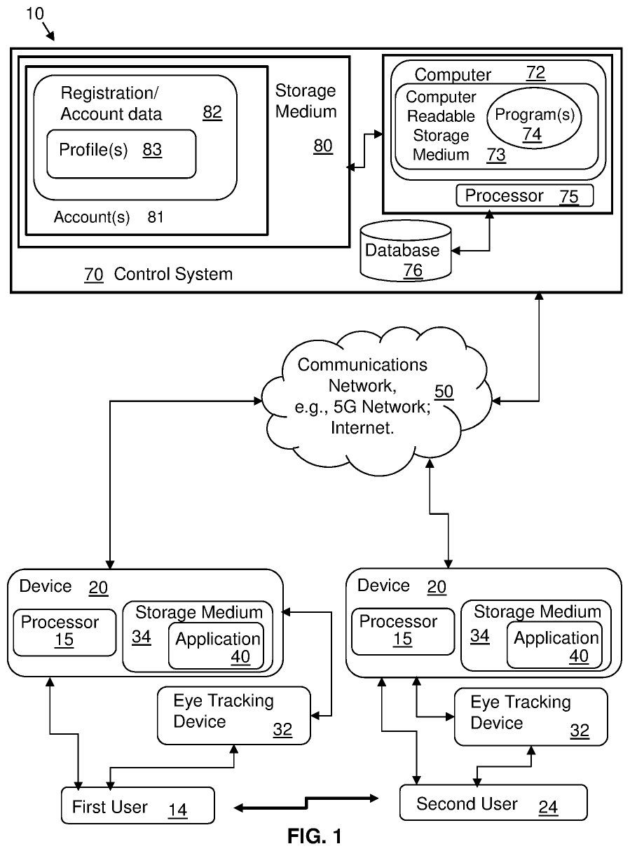

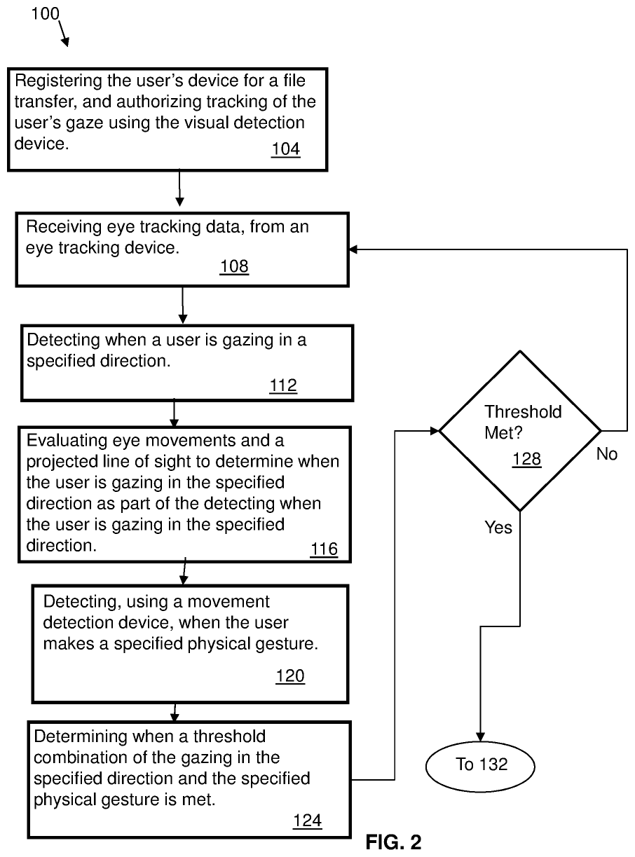

Referring to FIGS. 1 and 2, a method 100 (FIG. 2) with reference to a system 10 (FIG. 1) according to an embodiment of the present disclosure is provided for initiating file transfers between devices based on a combination of a gaze of a user and a physical gesture of one or more users. In one embodiment the method according to the present disclosure, an eye tracking device user can track the eye movements of a user. From eye tracking data provided by the eye tracking device, a line of sight of the user and/or directional information for the gaze of the user can be determined.

Referring to FIG. 2, a method 100 according to an embodiment of the present disclosure includes registering a user's device for a file transfer, and in addition, authorizing tracking of the user's gaze using the eye tracking device as in block 104. Such registration can include registration data or account data 82 stored in a computer readable storage medium 80 on a control system 70, where the registration data is part of accounts 81 for each of the users of the system. The control system can include one or more remote servers or be part of a remote server system. The registration data can include profiled 83 for each of the users of the system.

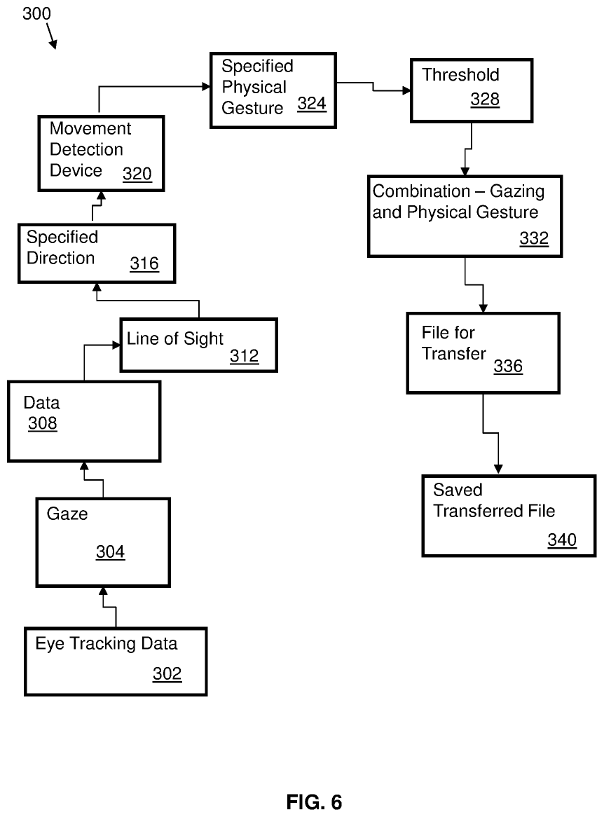

The method 100 includes receiving eye tracking data (as shown in FIG. 6), from an eye tracking device 32, as in block 108. The eye tracking device can be set to scan a user's eye movements to determine line of sight and/or directional information for the gaze of the user. In the method 100, eye tracking device 32 is detecting and scanning the eyes of a first user 14.

Using the eye tracking device 32, and/or the eye tracking data 302, the method includes detecting when a user is gazing in a specified direction, as in block 112. For example, a specified direction of a gaze 304 can be a user gazing at a device or electrical component, or at a person or in a person's direction.

In one example, the eye tracking device or devices can comprise one or more cameras looking toward, or pointing towards, a user's eyes and adapted to trach eye movements. The eye tracking device can analyze the camera data to determine the direction of the gaze of the user. Such data being referred to herein as eye tracking data 308, or gaze data 308 (see FIG. 6). In one example, the user can be using a head-up display (HUD) which can use a combination of software and/or hardware modules or units. In one example, sight component of an eye tracking device can include an emitter and a detector for sending and receiving signals, respectively, to other devices (e.g., devices within a line of sight, cone of sight, area of sight, or field of view of a HUD system or user).

It is understood that the features shown in FIG. 6 are functional representations of features of the present disclosure. Such features are shown in embodiments of the systems and methods of the present disclosure for illustrative purposes to clarify the functionality of features of the present disclosure.

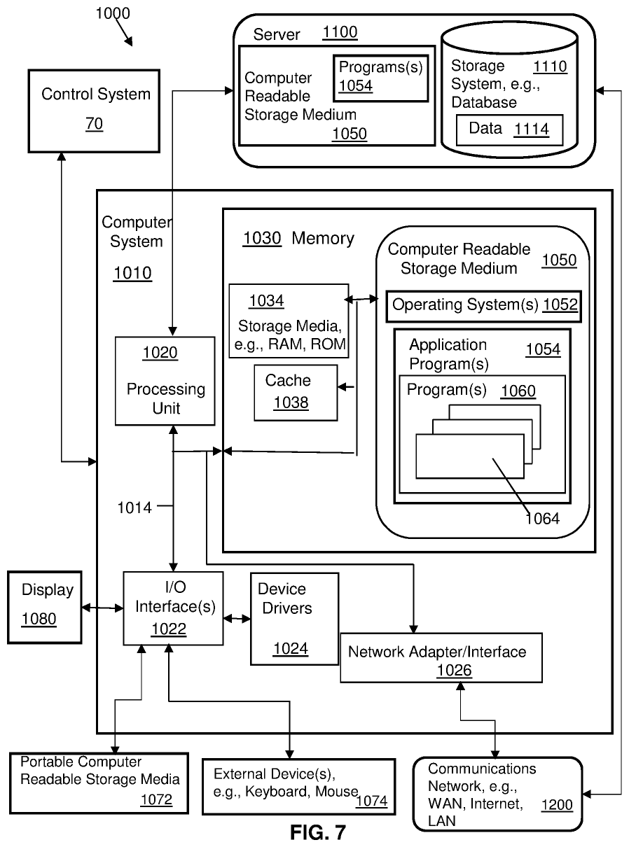

The method 100 according to an embodiment of the present disclosure, can be incorporated in one or more computer programs or an application 40 stored on an electronic storage medium 34, and executable by a processor 15, as part of a computer on a device 20 associated with one or more users. For example, a first user 14 has a device 20, and the device can communicate with an eye tracking device or incorporate an eye tracking device, e.g., a camera. The application can be stored, all or in part, on a computer or a computer in a mobile device and at a control system communicating with the device, for example, using a communications network 50, such as the Internet. It is envisioned that the application can access all or part of instructions necessary to implement the method of the present disclosure. The program or application can communicate with a remote computer system via a communications network 50 (e.g., the Internet) and access data, and cooperate with program(s) stored on the remote computer system. Such interactions and mechanisms are described in further detail herein and referred to regarding components of a computer system, such as computer readable storage media, which are shown in one embodiment in FIG. 7 and described in more detail in regards thereto referring to one or more computer systems 1010.

Thus, in one example, a control system is in communication with the device(s) 20, and the device 20 can include the application 40. The device 20 communicates with the network 50 and the control system 70 using the communications network 50.

The method 100 includes evaluating eye movements 302 and generating a projected line of sight 312 from the eye tracking and gazing data 304. In one embodiment, a pairing of eye tracking devices can determine that a first person is looking at a second person and that the second person is looking at the first person at the same time. During a registration, a linkage is set up between a person and a device. This linkage can be used to match a person using supplied biometric data or via electronic signatures of devices a person is carrying. In another embodiment, the eye gazing tracking devices can be an intelligent set of glasses, and the registration can allow for transmission of validating information between the devices. The projected line of sight can be used to determine when a user is gazing in a specified direction and/or direction, as in block 116.

The method 100 includes detecting, using a movement detection device 320 (FIG. 6), when the user makes a specified physical gesture 324, as in block 120. In one example, one or more cameras can detect movement of a user. Additionally, a video feed captured from a camera can be evaluated to determine when a specified gesture is made by the user. Such cameras can be part of a computer or attached to computer as a peripheral device. For instance, a specified gesture can include a hand signal, or a head movement, such as a head nod, or turning of a head in a direction. Such examples are intended to be examples and non-exhaustive.

The method further includes determining when a threshold 328 combination of the gazing in the specified direction and the specified physical gesture is met, as in block 124. For example, a threshold can include a specific combination of gazing and physical gesture, for example, the combination can include a gaze in a specific direction and/or at a specific device or person, and a specified gesture(s), in one example, such as a head nod. In another example, a threshold can include a time requirement, for example, an overlapping time period of a gazing direction and a physical gesture. In another example, a gesture can include a negative response which would preclude the transfer from being initiated.

Additionally, in another example, a combination of gazing and physical gesture 332 can include, for example, a threshold time period for the combination of the gaze and the physical gesture. For example, in one example, a threshold can be that the gaze and the physical gesture occur at the same time. In another example, the gaze and the physical gesture can be considered occurring simultaneously if and when the occurrence of both overlap. In another example, the gaze and the physical gesture can be considered as occurring in combination if they occur in the same time period but not necessary overlapping, such as a user gazes in a specified direction, and a few seconds (for example 1-5 seconds) later makes a physical gesture after looking in the specified direction or in a specified line of sight. In another example, a time period for the combination of the gaze and the physical gesture occurring together or simultaneously or concurrently can include a set time period, for example, 1-3 seconds, or 1-10 seconds. In another example, the combination of the gaze and the physical gesture can be defined as any time the two occur simultaneously or overlap, for example, a user maintains a line of sight in a specified direction, and at one point in time, while maintain the line of sight, the user makes the specified physical gesture—meeting the definition of an overlapping or concurrent combination.

The method determines when the threshold is met in block 128. If the threshold has not been met, the method returns to block 108 to receive eye tracking data. When the threshold is met, the method proceeds to block 132.

The method includes transferring 336 a specified file to a specified location, in response to the threshold combination being met. In one example, a specified location can be a computer, having a computer readable storage medium. In another example, the specified location can be a computer readable storage device on another device of the user. In another example, the specified location can be a computer readable storage device on another user's device. In another example, the specified location can be a device of the user or another user.

A specified file can be a file selected by a user, for example, by using a mouse and GUI (Graphical User Interface) interface, or by a pre-programmed file selection process, for instance for transferring files added to a folder. In another example, a specified file can include a file identified by verbal commands by a user and initiated after identification by a computer using NLP (Natural Language Processing).

In one embodiment, transferring of the specified file can include a communications network, such as a local area network, or a wide area network. In another example, transferring can include a wireless network or a cellular network which can transfer one or more photos or files to devices or smart devices. The transferred file 336 can be transferred from the first user's 14 device 20 to another device, or a file storage device, or another user′ device such as the second user's 24 device 20. The transferred file can be saved 340 on another device on a computer readable storage medium.

Transferring a file can include using a cell phone or laptop computer to send photos or files via text messages (SMS), Multimedia Messaging Service (MMS) (related to SMS), email, or a web browser. Thus, the transferring of a specified filed can include sending a file from one user mobile device to another user mobile device or smart devices.

### Another Embodiment

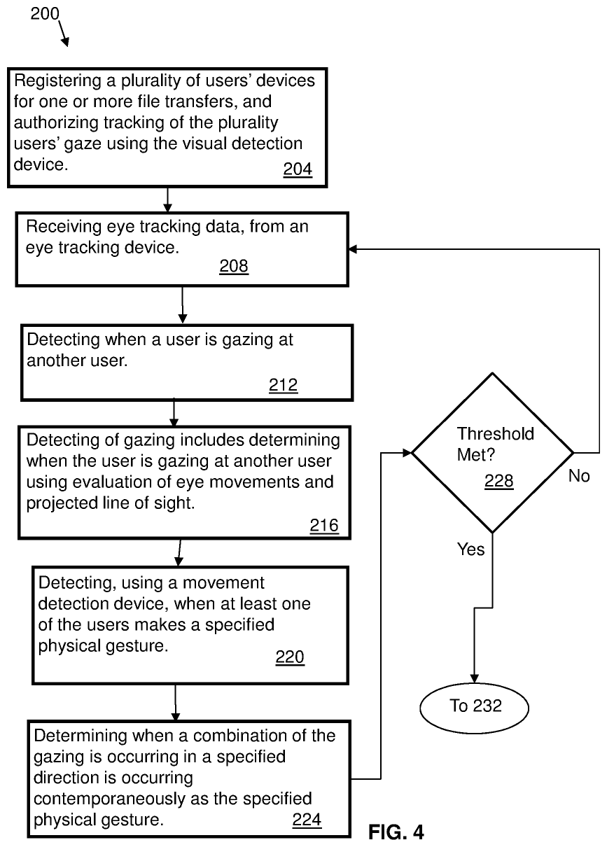

In another embodiment according to the present disclosure, referring to FIG. 4, a method 200 includes registering a plurality of users' devices for one or more file transfers. In addition, the method includes authorizing tracking of one or more of the users' gazes using one or more visual detection devices as in block 204.

The method 200 includes receiving eye tracking data, from one or more eye tracking device, as in block 208. An eye tracking device can be set to scan a user's eye movements to determine line of sight and/or directional information for the gaze of the user. Such an eye tracking device can include a camera, which can be separate or part of a computer or device, and adapted to detect and ascertain eye movement.

Using the eye tracking device, and/or the eye tracking data, the method includes detecting when a user is gazing at another user, as in block 212. The method 100 includes evaluating eye movements and a projected line of sight from the received eye tracking data to determine when a user is gazing at the another user, as in block 216. For example, the first user 14 can be gazing at the second user 24. The method 200 includes detecting gazing which includes determining when at least of two or more users are gazing at another user using evaluation of eye movements and projected line of sight, as in block 216. In one example, one user can be gazing at one or more other users.

The method 200 can include detecting, using a movement detection device, when at least one of the users makes a specified physical gesture, as in block 220. For example, the system can detect when the second user makes a specified gesture, which gesture indicates that the second user wants to or approves receiving the specified file. In another example, the first user can gaze at the user to whom a file transfer is chosen, and can also initiate a gesture for transferring the file.

The method 200 includes determining when a combination of the gazing is occurring in a specified direction is occurring contemporaneously as the specified physical gesture, as in block 224. For example, a gaze can occur contemporaneously as a specified physical gesture, in one example the first user can gaze at the second user or at a device, and the second user can perform the specified physical gesture at the same time as the gaze is occurring. In another example, contemporaneously can be defined as within a period of time, for example, within five second of the gaze. In another example, the gaze and the specified physical gesture can be defined as being required to occur concurrently or at a same time or nearly at the same time. For example, the first user can gaze at the second user, and the second user perform the physical gesture while the gaze is occurring, or in another example, the first user can initiate the gaze and the specified physical gesture can occur nearly simultaneously, for example, within a few seconds of the gaze as in response to the gaze.

The method determines when a threshold is met in block 228. The threshold being determined as discussed above as the combination of gazing and a specified physical gesture occurring contemporaneously, or simultaneously, or concurrently. If the threshold has not been met, the method returns to block 208 to receive eye tracking data. When the threshold is met, the method proceeds to block 232.

The method 200 includes transferring a specified file to a specified location, in response to the determination that the combination of the gazing in the specified direction is occurring contemporaneously at the same time as the specified physical gesture, as in block 232.

In one example, an eye tracking device can be selected from a group which includes: a camera; a mobile device camera; a video camera, and a computer camera.

In another example, defining a threshold time for the combination of the gazing occurring in the specified direction and the specified physical gesture occurring contemporaneously. In another example, the combination of the gazing in the specified direction can occur near simultaneously with the specified physical gesture. In another example, the combination of the gazing in the specified direction can occur in an overlapping time period. In another example, the combination of the gazing in the specified direction can occur within a defined time period.

In another embodiment, the method can receive eye tracking data and motion detection data at a control system 70 from a vehicle. In another example, data can be received from a combination of a control system and one or more devices. In one example, the control system 70 can have a front-end computer at a location with the users, and a back-end computer embodied as the control system. In another example, the control system 70 can be all or part of an Artificial Intelligence (AI) system.

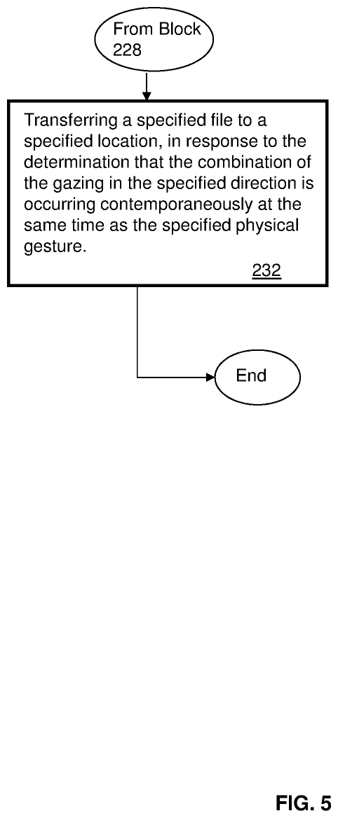

Also, referring to FIG. 1, the device 20 can include a computer, computer readable storage medium, and operating systems, and/or programs, and/or a software application. These features are shown herein in FIG. 1, and also in a generic embodiment of a computer system shown in FIG. 5 referring to one or more computer systems 1010.

### Another Embodiment

In one embodiment according to the present disclosure, a method and system to determine if file transfers between two or more parties should be initiated includes registering parties and associated devices. In one example, a user/individual can opt-in to register with a system. The system can identify information which is stored in the system. Locations of target files can be stored in the system. Supplemental personalized motions can be stored in the system with associated meaning. Supplemental cameras can be registered for providing information.

The method includes identifying a file to be transferred. Identifying can occur using NLP (Natural Language Processing) or a GUI (Graphical User Interface). The method includes determining if a file gaze is going to be supplemented with body gestures. If yes, the method can capture one or more body gestures of a receiving party. Then, the method compares body movements (e.g., a hand gesture, or a head movement) to a corpus of identified movements. A corpus of identified movements can be created by loading/storing common body motions into the system. The system can be trained with multiple individuals to recognize motions. The training can include linking a motion to a meaning (e.g., confirm/deny).

The method can determine if the motion is a positive or negative motion based on metadata. Thus, the users, e.g., a receiving party, signals to accept the file or deny the file transfer. If and when a positive motion is detected, the method initiates a file transfer. If a negative or a motion indicating no is detected, a file transfer is cancelled. If conflicting motions are detected, then a file transfer identification process is restarted, and parties notified. The method includes determining if body gestures are going to be used in a standalone process. If yes, the method captures body gestures of the receiving parties and compares body movements to a corpus of identified movements. The method determines if the motion is a positive or negative motion based on metadata. If positive motion is detected, the method initiates transfer to that party, i.e., the party that makes the positive motion. If negative or no motion is detected, file transfer is cancelled, and/or not initiated.

In one example, the method includes capturing body gestures of the receiving parties, and comparing body movements to a corpus of identified movements. The method determines if the motion is a positive or negative motion based on metadata. If a positive motion is detected, a transfer is initiated to that party, if a negative or no motion is detected, a file transfer is cancelled.

If conflicting motions are detected, then the method re-starts a file transfer identification process and conflicted parties are notified. Other steps can include, determining if supplemental target location is provided, identifying body motions for an individual, and if a person has multiple target locations for their files, link a body motion to each location, and share the file with the identified location. In another example, multiple motions can be associated with a singular location.

Specifically, regarding the control system 70, the devices 20 of the first and second users can be in communication with the control system 70 via the communications network 50. In the embodiment of the control system shown in FIG. 1, the control system 70 includes a computer 72 having a database 76 and one or more programs 74 stored on a computer readable storage medium 73. In the embodiment of the disclosure shown in FIG. 1, the devices 20 communicate with the control system 70 and the one or more programs 74 stored on a computer readable storage medium 73. The control system includes the computer 72 having a processor 75, which also has access to the database 76.

The control system 70 includes a storage medium 80 for maintaining a registration 82 of users and their devices for content analysis 228. Such registration can include user profiles 83, which can include user data supplied by the users in reference to registering and setting-up an account. In an embodiment, the method and system which incorporates the present disclosure includes the control system (generally referred to as the back-end) in combination and cooperation with a front end of the method and system, which can be the application 40. In one example, the application 40 is stored on a device, for example, the device 20, and can access data and additional programs at a back end of the application, e.g., control system 70.

The control system can also be part of a software application implementation, and/or represent a software application having a front-end user part and a back-end part providing functionality. In an embodiment, the method and system which incorporates the present disclosure includes the control system (which can be generally referred to as the back-end of the software application which incorporates a part of the method and system of an embodiment of the present application) in combination and cooperation with a front end of the software application incorporating another part of the method and system of the present application at the device, as in the example shown in FIG. 1 of devices 20 having the application 40. The application 40 is stored on the devices 20 and can access data and additional programs at the back end of the application, for example, in the program(s) 74 stored in the control system 70.

The program(s) 74 can include, all or in part, a series of executable steps for implementing the method of the present disclosure. A program, incorporating the present method, can be all or in part stored in the computer readable storage medium on the control system or, in all or in part, on a device 20. It is envisioned that the control system 70 can not only store the profile of users, but in one embodiment, can interact with a website for viewing on a display of a device, using the 5G network, or in another example the Internet, and receive user input related to the method and system of the present disclosure. It is understood that FIG. 1 depicts one or more profiles 83, however, the method can include multiple profiles, users, registrations, etc. It is envisioned that a plurality of users or a group of users can register and provide profiles using the control system for use according to the method and system of the present disclosure.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Such approval also includes a user's option to cancel such profile or account, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner.

It is also understood that the method 100 according to an embodiment of the present disclosure, can be incorporated into (Artificial Intelligence) AI devices, which can communicate with respective AI systems, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

It is understood that as discussed herein, a download or downloadable data can be initiated using a voice command or using a mouse, touch screen, etc. In such examples a mobile device can be user initiated, or an AI device can be used with consent and permission of users. Other examples of AI devices include devices which include a microphone, speaker, and can access a 5G network or the Internet, for example, a vehicle having a computer and having cellular or satellite communications, or in another example, IoT (Internet of Things) devices such as appliances having 5G, or Internet access.

Referring to FIG. 7, a system or computer environment 1000 includes a computer system 1010 shown in the form of a generic computing device. The method 100, for example, may be embodied in a program 1060, including program instructions, embodied on a computer readable storage device, or a computer readable storage medium, for example, generally referred to as computer memory 1030 and more specifically, computer readable storage medium 1050. Such memory and/or computer readable storage media includes non-volatile memory or non-volatile storage, also known and referred to non-transient computer readable storage media, or non-transitory computer readable storage media. For example, such non-volatile memory can also be disk storage devices, including one or more hard drives. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, the system or computer environment 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that the control system 70 can include all or part of the computer system 1010 and its components, and/or the control system can communicate with all or part of the computer system 1010 and its components as a remote computer system, to achieve the control system functions described in the present disclosure. It is also understood that the one or more computers or computer systems shown in FIG. 1 similarly can include all or part of the computer system 1010 and its components, and/or the one or more computers can communicate with all or part of the computer system 1010 and its components as a remote computer system, to achieve the computer functions described in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions. For example, a program embodying a method according to the present disclosure can be embodied in, or encoded in, a computer readable storage medium, or in another example, embodied or encoded in a non-transient computer readable storage medium.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

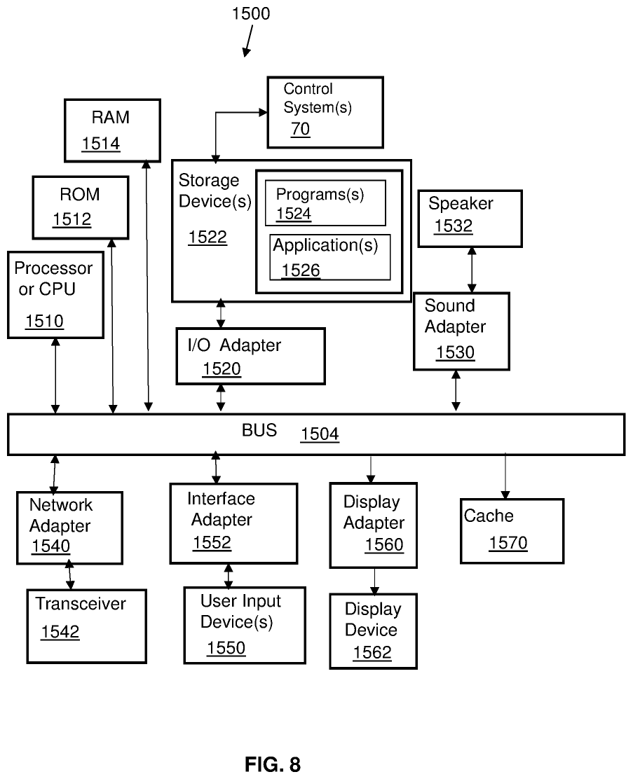

Referring to FIG. 8, an example system 1500 for use with the embodiments of the present disclosure is depicted. The system 1500 includes a plurality of components and elements connected via a system bus 1504 (also referred to as a bus). At least one processor (CPU) 1510, is connected to other components via the system bus 1504. A cache 1570, a Read Only Memory (ROM) 1512, a Random Access Memory (RAM) 1514, an input/output (I/O) adapter 1520, a sound adapter 1530, a network adapter 1540, a user interface adapter 1552, a display adapter 1560 and a display device 1562, are also operatively coupled to the system bus 1504 of the system 1500.

One or more storage devices 1522 are operatively coupled to the system bus 1504 by the I/O adapter 1520. The storage device 1522, for example, can be any of a disk storage device (e.g., a magnetic or optical disk storage device), a solid state magnetic device, and so forth. The storage device 1522 can be the same type of storage device or different types of storage devices. The storage device can include, for example, but not limited to, a hard drive or flash memory and be used to store one or more programs 1524 or applications 1526. The programs and applications are shown as generic components and are executable using the processor 1510. The program 1524 and/or application 1526 can include all of, or part of, programs or applications discussed in the present disclosure, as well vice versa, that is, the program 1524 and the application 1526 can be part of other applications or program discussed in the present disclosure. The storage device can communicate with the control system 70 which has various functions as described in the present disclosure.

A speaker 1532 is operatively coupled to system bus 1504 by the sound adapter 1530. A transceiver 1542 is operatively coupled to system bus 1504 by the network adapter 1540. A display 1562 is operatively coupled to the system bus 1504 by the display adapter 1560.

One or more user input devices 1550 are operatively coupled to the system bus 1504 by the user interface adapter 1552. The user input devices 1550 can be, for example, any of a keyboard, a mouse, a keypad, an image capture device, a motion sensing device, a microphone, a device incorporating the functionality of at least two of the preceding devices, and so forth. Other types of input devices can also be used, while maintaining the spirit of the present invention. The user input devices 1550 can be the same type of user input device or different types of user input devices. The user input devices 1550 are used to input and output information to and from the system 1500.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

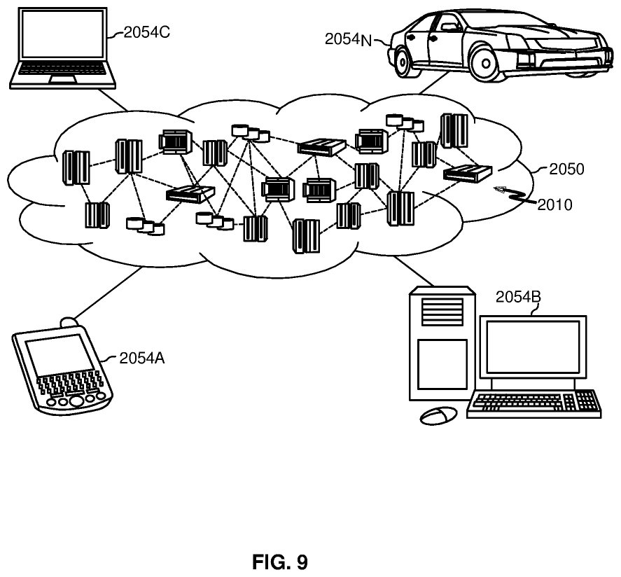

Referring now to FIG. 9, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 9 are intended to be illustrative only and that computing nodes 2010 and cloud computing environment 2050 can communicate with any type of computerized device over any type of network and/or network addressable connection (e.g., using a web browser).

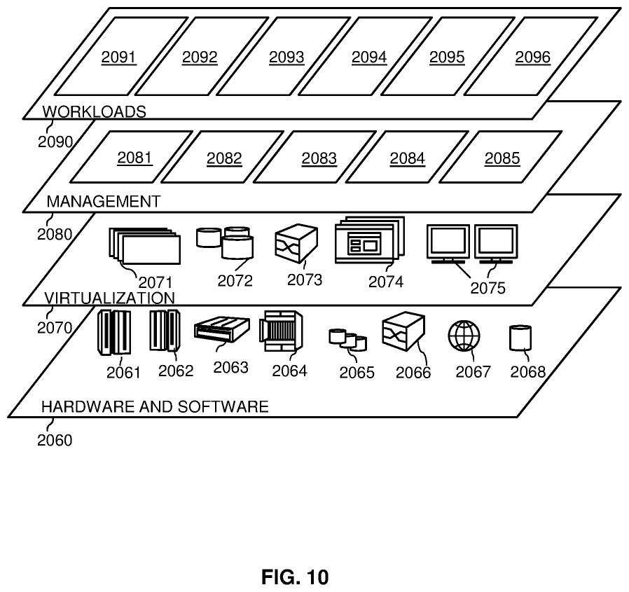

Referring now to FIG. 10, a set of functional abstraction layers provided by cloud computing environment 2050 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and initiating file transfers between devices based on a combination of a gaze of a user and a physical gesture of one or more users 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for initiating file transfers between devices based on a combination of a gaze of a user and a physical gesture of one or more users, comprising:
detecting, using an eye tracking device, when a user is gazing in a specified direction;
detecting, using a movement detection device, when the user makes a specified physical gesture;
determining when a threshold combination of the gazing in the specified direction and the specified physical gesture is met; and
transferring a specified file to a specified location, in response to the threshold combination being met.

2. The method of claim 1, further comprising:
registering the user's device for a file transfer, and authorizing tracking of the user's gaze using the visual detection device.

3. The method of claim 1, wherein the detecting of gazing includes determining when the user is gazing at in the specified direction using evaluation of eye movements and projected line of sight.

4. The method of claim 1 further comprising:
detecting gazing, using one or more eye tracking devices, between two or more users;
detecting, using a movement detection device, when at least one of the users makes a specified physical gesture;
determining when a threshold combination of the gazing is occurring in a specified direction and the specified physical gesture is met; and
transferring a specified file to a specified location, in response to the determination that the combination of the gazing in the specified direction is occurring contemporaneously as the specified physical gesture.

5. The method of claim 4, further comprising:
registering a plurality of devices for respective users for a file transfer, and
authorizing gaze tracking for a plurality of users.

6. The method of claim 4, wherein the detecting of gazing includes determining when at least one of the two or more users are gazing at another one of the two or more users using evaluation of eye movements and projected line of sight.

7. The method of claim 1 further comprising:
detecting gazing, using one or more eye tracking devices, between two or more users;
detecting, using a movement detection device, when at least one of the users makes a specified physical gesture;
determining when a combination of the gazing is occurring in a specified direction is occurring contemporaneously as the specified physical gesture; and
transferring a specified file to a specified location, in response to the determination that the combination of the gazing in the specified direction is occurring contemporaneously as the specified physical gesture.

8. The method of claim 1, wherein the eye tracking device is selected from a group consisting of: a camera; a mobile device camera; a video camera, and a computer camera.

9. The method of claim 1, further comprising:
defining a threshold time for the combination of the gazing occurring in the specified direction occurring contemporaneously with the specified physical gesture.

10. The method of claim 1, wherein the threshold combination defines the combination of the gazing in the specified direction occurring contemporaneously with the specified physical gesture.

11. The method of claim 10, wherein the combination of the gazing in the specified direction occurs near simultaneously with the specified physical gesture.

12. The method of claim 10, wherein the combination of the gazing in the specified direction occurs in an overlapping time period.

13. The method of claim 10, wherein the combination of the gazing in the specified direction occurs in within a defined time period.

14. A system for initiating file transfers between devices based on a combination of a gaze of a user and a physical gesture of one or more users, which comprises:
a computer system comprising: a computer processor, a computer-readable storage medium, and program instructions stored on the computer-readable storage medium being executable by the processor, to cause the computer system to perform functions, by the computer, comprising, the following functions to:
detect, using an eye tracking device, when a user is gazing in a specified direction;
detect, using a movement detection device, when the user makes a specified physical gesture;
determine when a threshold combination of the gazing in the specified direction and the specified physical gesture is met; and
transfer a specified file to a specified location, in response to the threshold combination being met.

15. The system of claim 14, further comprising the following function to:
register the user's device for a file transfer, and authorizing tracking of the user's gaze using the visual detection device.

16. The system of claim 14, wherein the detecting of gazing includes determining when the user is gazing at in the specified direction using evaluation of eye movements and projected line of sight.

17. The system of claim 14, further comprising the following function to:
detect gazing, using one or more eye tracking devices, between two or more users;
detect, using a movement detection device, when at least one of the users makes a specified physical gesture;
determine when a threshold combination of the gazing is occurring in a specified direction and the specified physical gesture is met; and
transfer a specified file to a specified location, in response to the determination that the combination of the gazing in the specified direction is occurring contemporaneously as the specified physical gesture.

18. The system of claim 17, further comprising the following function to:
register a plurality of devices for respective users for a file transfer, and
authorizing gaze tracking for a plurality of users.

19. The system of claim 17, wherein the detecting of gazing includes determining when at least one of the two or more users are gazing at another one of the two or more users using evaluation of eye movements and projected line of sight.

20. A computer program product for cognitive data analytics for initiating file transfers between devices based on a combination of a gaze of a user and a physical gesture of one or more users, the computer program product comprising a computer readable storage medium having program instructions embodied therewith, the program instructions executable by a computer to cause the computer to perform functions, by the computer, comprising the functions to:
detect, using an eye tracking device, when a user is gazing in a specified direction;
detect, using a movement detection device, when the user makes a specified physical gesture;
determine when a threshold combination of the gazing in the specified direction and the specified physical gesture is met; and
transfer a specified file to a specified location, in response to the threshold combination being met.
